(19) United States
(12) Patent Application Publication
(10) Pub. No.: US 2002/0145039 A1
(43) Pub. Date: Oct. 10, 2002

(54) Apparatus and method for selling lottery tickets at fuel dispensers

(76) Inventor: Seamus Carroll, Cold Spring, NY (US)

Correspondence Address: Norman H. Zivin, Cooper & Dunham LLP, 1185 Avenue of the Americas, New York, NY, 10036, US

(21) Appl. No.: 09/829,814

(22) Filed: Apr. 10, 2001

(51) Int. Cl. G07B 15/02

(52) U.S. Cl. 235/384

(57) ABSTRACT

An apparatus and a method are provided for selling gaming tickets at a fuel dispenser. A kiosk is provided in a physical proximity of the fuel dispenser. The kiosk has a gaming controller and a communication interface through which the kiosk can communicate electronically with a remote gaming machine and with the fuel dispenser. The gaming controller monitors whether a user is using the fuel dispenser, and then, after it is determined that the fuel dispenser is being used, triggers a user interface through which the user can select a desired game of chance. After the user selects a game of chance, gaming data corresponding to the selected game is then communicated electronically to the remote gaming machine from the kiosk.

### BACKGROUND OF THE INVENTION

The present invention relates to marketing merchandise at fuel dispensers. In particular, the invention relates to selling lottery and other gaming tickets through a kiosk at retail fuel dispensers.

Technology and opportunity have converged, presenting many opportunities to market merchandise by using new age media for a traditional enterprise. Marketing opportunities may take advantage of, for example, consumers' desire for convenience. Such marketing opportunities may be available when a consumer is not occupied by activities that require the consumer's full attention, such as while refueling the consumer's vehicle at a gas station.

Recently, it has been proposed, such as in U.S. Pat. Nos. 5,945,975 and 6,152,591, to provide advertisements and other messages on a graphic display at a gas pump. Thus, messages intended to provoke the consumer's impulses for buying merchandise, such as lottery tickets, may be displayed.

The mere display of advertisements does not, however, take advantage of impulse purchase tendencies of consumers who want to refuel their vehicle and proceed on their way. For example, such a consumer may not be inclined to take the time to walk over to the convenience store or gas station nearby, and, perhaps after waiting on a line, purchase lottery tickets. The consumer, however, is more likely to purchase lottery and other gaming tickets at or near the gas pump, if she/he could do so conveniently without leaving the vicinity of the vehicle and gas pump. It is known to place a kiosk in a location for general (e.g., public) access of users/customers so that a service provider can provide a service to these users/customers. Typically, these services are “self-services” that are conducted by the user/customer without the service provider providing an agent to offer specific help to the customer. Therefore, the services tend to be simple, such as obtaining information (e.g., a store/mall floor map, etc.), and/or completing certain simple transactions (e.g., buying tickets for transportation or entertainment events, getting cash, etc.).

### SUMMARY OF THE INVENTION

The present invention provides an apparatus for selling gaming tickets at a fuel dispenser comprising, in accordance with one embodiment, a communication interface and a gaming controller. The communication interface includes a first interface and a second interface, wherein the first interface is adapted to communicate electronically with a remote gaming machine, and the second interface is adapted to communicate electronically with the fuel dispenser. The gaming controller is adapted to input a selection by a user of a game of chance, and coupled to the communication interface to communicate with the remote gaming machine and with the fuel dispenser. The apparatus may be a gaming ticket kiosk unit distinct from the fuel dispenser. In accordance with another embodiment, the gaming ticket kiosk may be integrated in the fuel dispenser.

The apparatus communicates electronically with the fuel dispenser through the communication interface and, in accordance with one embodiment, a kiosk server. In accordance with another embodiment, the apparatus communicates electronically with the fuel dispenser through the communication interface and a network dispenser interface. In accordance with another embodiment, the apparatus communicates electronically with the fuel dispenser through the communication interface, the kiosk server and the network dispenser interface.

The apparatus may communicate electronically with a central gaming computer through the communication interface and, in accordance with one embodiment, the kiosk server. In accordance with another embodiment, the apparatus communicates electronically with the central gaming computer through the communication interface, the kiosk server and an in-store gaming computer. Alternatively, the apparatus communicates electronically with the central gaming computer through the communication interface and the network dispenser interface. In accordance with another embodiment, the apparatus communicates electronically with a central gaming computer through the communication interface, a network dispenser interface and an in-store gaming computer.

The selected game may be a lottery or a legal game of chance other than a lottery. The remote gaming machine may include, in accordance with one embodiment, a central lottery computer. The gaming controller may include means for the user to select one or more desired lottery numbers. Gaming data communicated from the gaming controller through the first interface to the remote gaming machine may include a request for a Quick Pick.

The apparatus may further comprise a display screen, wherein Quick Pick numbers (by, for example, a random selection of lottery or gaming numbers by a computer or other random number selection device) from the remote gaming machine are received through the first interface and displayed on the display screen. The display may include a touchscreen display, wherein graphical information corresponding to the game of chance is displayed on the touchscreen display. The consumer may select specific lottery numbers (or other gaming parameters) through a keypad interface in the touch screen or in a keypad separate from the display. The display may include a video display, wherein an infomercial corresponding to the game of chance is selectively displayed on the video display.

The apparatus may further comprise a printer, wherein after a gaming transaction is completed, a gaming ticket (for example, similar to those obtained from a gaming machine in a store) and/or a receipt of the gaming transaction is printed by the printer. In accordance with another embodiment, the printer is integrated with the fuel dispenser. After confirmation of the selected game is received by the apparatus through the first interface from the remote gaming machine, a request for the integrated printer of the fuel dispenser to print a gaming receipt corresponding to the selected game is communicated to the fuel dispenser through the second interface. Further, an instant prize coupon for discount on selected merchandise may be printed by the printer for selected customers.

The apparatus may further comprise a card reader, and the communication interface may further comprise a third interface adapted to communicate electronically with a credit agency (or other bank or financial institution). Card data is obtained through the card reader from a transaction card (for example, a credit card, a debit card or other financial transaction card) supplied by the user, and transaction data and the card data are communicated through the third interface to the credit agency. After approval of credit for the gaming transaction is communicated by the credit agency to the apparatus through the third interface, gaming data corresponding to the selected game may be communicated to the remote gaming machine through the first interface.

It should be noted that while reference is made herein to a credit agency, the references apply similarly to other bank or financial institutions.

In accordance with another embodiment, card data is obtained through a card reader integrated with the fuel dispenser from a transaction card supplied by the user to initiate a fuel purchase transaction, and the card data obtained through the card reader is communicated electronically from the fuel dispenser to the apparatus through the communication interface. The communication interface may comprise a third interface adapted to communicate electronically with a credit agency, and transaction data and the card data are communicated through the third interface to the credit agency, after the selected game is selected by the user, to obtain approval of credit for the gaming transaction. The apparatus may further comprise a cash acceptor, wherein cash payment for a gaming transaction is accepted through the cash acceptor.

The present invention also provides a method of selling gaming tickets at a fuel dispenser, comprising, in accordance with one embodiment, (a) providing a gaming ticket kiosk in a physical proximity of the fuel dispenser, wherein the gaming ticket kiosk has a gaming controller and a communication interface, (b) monitoring through the gaming controller whether fuel is being dispensed by the fuel dispenser, (c) providing a user interface through which a user can select a desired game of chance, after it is determined in step (b) that fuel is being dispensed by the fuel dispenser, and (d) communicating electronically through the communication interface to a remote gaming machine from the gaming ticket kiosk gaming data corresponding to a selected game.

In accordance with another embodiment, the method comprises (a) monitoring through the gaming controller whether the fuel dispenser is being used, (b) providing a user interface through which a user can select a desired game of chance, after it is determined in step (a) that the fuel dispenser is being used, and (c) communicating electronically through a communication interface to a remote gaming machine from the gaming ticket kiosk gaming data corresponding to the desired game selected through the user interface provided in step (b).

The method may further comprise receiving a signal at the gaming ticket kiosk from the fuel dispenser when a fuel purchase transaction commences at the fuel dispenser. In accordance with another embodiment, the method may further comprise receiving a signal at the gaming ticket kiosk from the fuel dispenser when a fuel pump handle at the fuel dispenser has been lifted from a resting position.

The method may further comprise adding to a fuel purchase transaction at the fuel dispenser a purchase of at least one gaming ticket corresponding to the selected game. The method may further comprise printing gaming receipts through a receipt printer of the gaming ticket kiosk. In accordance with another embodiment, the method further comprises printing gaming receipts through a receipt printer of the fuel dispenser. The method may further comprise printing an instant prize coupon for a discount on a selected merchandise, for selected users.

The method may further comprise communicating electronically with the fuel dispenser through the communication interface and, in accordance with another embodiment, a kiosk server. In accordance with another embodiment, the method further comprises communicating electronically with the fuel dispenser through the communication interface and a network dispenser interface. In accordance with another embodiment, the method further comprises communicating electronically with the fuel dispenser through the communication interface, the kiosk server and the network dispenser interface.

The method may further comprise communicating electronically with a central gaming computer through the communication interface and the kiosk server. In accordance with another embodiment, the method further comprises communicating electronically with a central gaming computer through the communication interface, a kiosk server and an in-store gaming computer. In accordance with another embodiment, the method further comprises communicating electronically with a central gaming computer through the communication interface and the network dispenser interface. In accordance with another embodiment, the method further comprises communicating electronically with a central gaming computer through the communication interface, the network dispenser interface and the in-store gaming computer.

The method may further comprise reading card data from a transaction card supplied by the user through a card reader integrated with the gaming ticket kiosk, and communicating transaction data and the card data to a credit agency to request approval of credit for the gaming transaction. In accordance with another embodiment, the method further comprises reading card data from a transaction card supplied by the user through a card reader integrated with the fuel dispenser, and communicating the card data to the gaming ticket kiosk.

### BRIEF DESCRIPTION OF THE DRAWINGS

The above and numerous other objectives, features and advantages that may be achieved by the present invention would be more readily understood from the following detailed description by referring to the accompanying drawings wherein:

FIG. 1A shows a view of a fuel dispenser and a gaming ticket kiosk, wherein the gaming ticket kiosk is a distinct unit from the fuel dispenser, according to one embodiment of the present invention;

FIG. 1B shows a view of a fuel dispenser with a gaming ticket kiosk integrated within a housing of the fuel dispenser, according to another embodiment of the present invention;

FIG. 1C shows a view of a fuel dispenser and a gaming ticket kiosk, wherein the gaming ticket kiosk is a distinct unit from the fuel dispenser and is adapted to include a card reader, according to another embodiment of the present invention;

FIG. 2A shows a schematic view of communication between the gaming ticket kiosk and fuel dispensers shown in FIGS. 1A-1C on the one hand, and a central gaming computer on the other hand, according to an embodiment of the present invention;

FIG. 2B shows a schematic view of communication between the gaming ticket kiosk shown in FIGS. 1A-1C on one hand and a central gaming computer and the fuel dispensers on the other hand, according to another embodiment of the present invention;

FIG. 2C shows a schematic view of communication between a gaming ticket kiosk shown in FIGS. 1A-1C on the other hand on one hand and a central gaming computer and the fuel dispensers, according to another embodiment of the present invention;

FIG. 2D shows a schematic view of communication between a gaming ticket kiosk shown in FIGS. 1A-1C on the other hand on one hand and a central gaming computer and the fuel dispensers, according to another embodiment of the present invention;

FIG. 2E shows a schematic view of communication between a gaming ticket kiosk shown in FIGS. 1A-1C on the other hand on one hand and a central gaming computer and the fuel dispensers, according to another embodiment of the present invention;

FIG. 2F shows a schematic view of communication between a gaming ticket kiosk shown in FIGS. 1A-1C on the other hand on one hand and a central gaming computer and the fuel dispensers, according to another embodiment of the present invention; and

FIG. 3 shows a block diagram of a system including any one of the gaming ticket kiosk shown in FIGS. 1A-1C and 2A-2F.

### DETAILED DESCRIPTION OF THE INVENTION

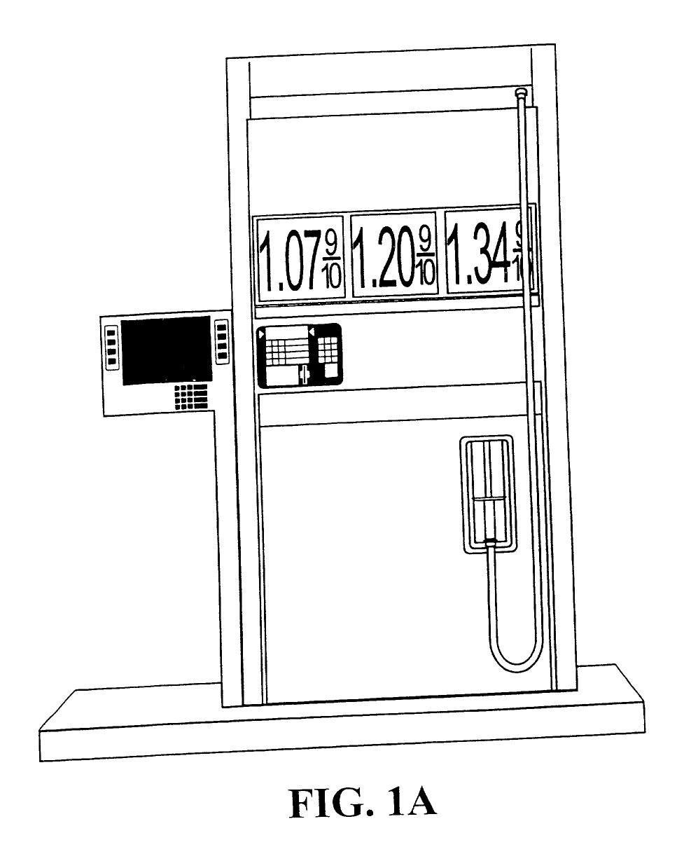

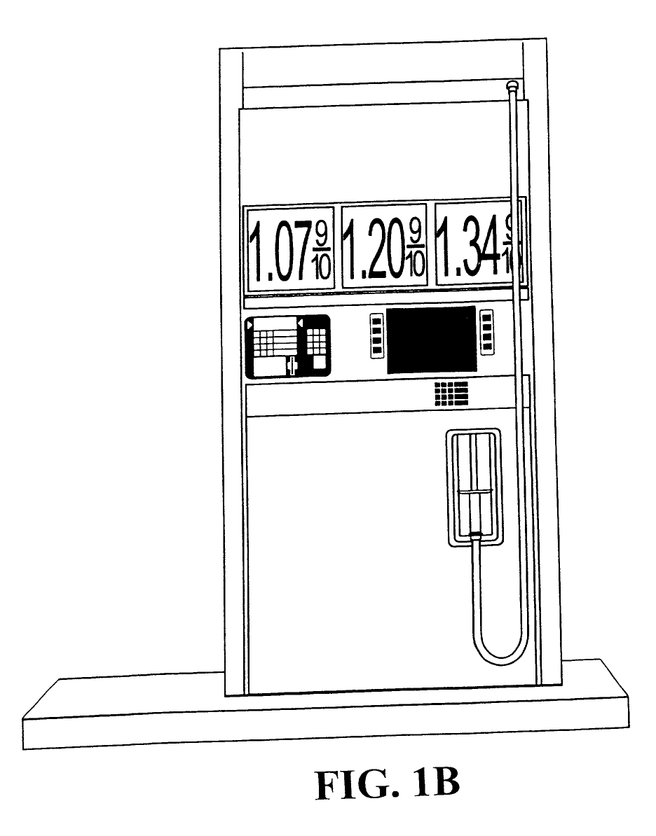

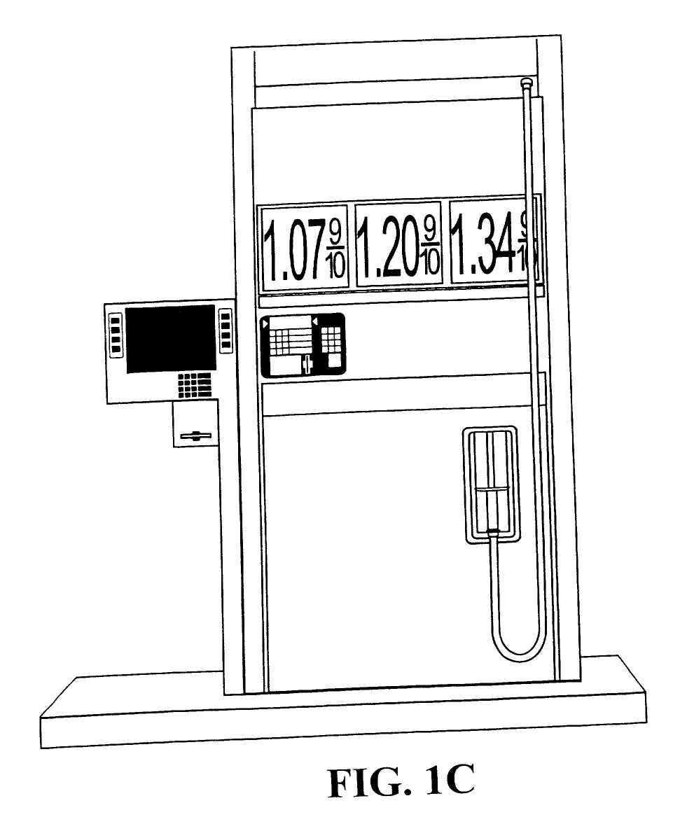

In accordance with the present invention, lottery and/or other gaming tickets (for example, scratch-off and other instant-win tickets) are sold at a fueling location through a gaming ticket kiosk with an interface for communicating with a remote gaming machine and an interface for communicating with a fuel dispenser. For example, the remote gaming machine may be a conventional type lottery machine located inside a convenience store or gas station office, or a central lottery computer. The kiosk may be a separate unit next to the fuel dispenser (see, for example, FIG. 1A), or integrated within a housing of the fuel dispenser (see, for example, FIG. 1B).

The kiosk may be triggered by operation at the fuel dispenser in the following manner, in accordance with one embodiment. The kiosk waits for a signal from the dispenser which indicates that the pump handle has been lifted or a transaction card (for example, credit card, debit card, convenience card, etc.) has been swiped through a card reader at the dispenser. The kiosk then runs through its user interface program, while the gas pump is operated to refuel a vehicle in a conventional fashion. For example, an infomercial for a lottery may be presented on a video display at the kiosk, while the vehicle is being refueled. The kiosk continually checks with the dispenser to determine if the pump handle has been placed back into the dispenser. After the handle replacement is signaled, the kiosk completes the current video segment and terminates the display program. If the customer purchases a lottery ticket or other merchandise through the kiosk or requests a coupon, the receipt or coupon may be printed on a receipt printer of the fuel dispenser or on a printer integrated with the kiosk.

A customer at the fuel dispenser to purchase gasoline may swipe his/her transaction card through the card reader integrated with the dispenser. After the card is swiped, card data and transaction data may be transmitted telecommunicatively to an appropriate credit agency or other bank or financial institution for approval of credit for the fuel purchase transaction. In addition, the card data, in accordance with one embodiment, also may be forwarded from the fuel dispenser to the kiosk, and the received data is held at the kiosk pending a transaction at the kiosk and/or completion of the gasoline purchase transaction.

The customer may decide to purchase one or more lottery tickets by pressing a button, for example, on the kiosk or graphically shown on a touchscreen display at the kiosk. After the button is pressed, various gaming selection features, such as for selecting a set of lottery numbers or requesting a “Quick Pick”, typically available at a conventional lottery machine may be provided on the display. For example, the customer may be prompted, in accordance with one embodiment, to operate a numeric or conventional numeric keypad to select the desired numbers. In accordance with another embodiment, the customer may pre-store a set of his/her favorite or desired numbers in a database, e.g., at a Web site or through the central lottery computer, and the customer is prompted at the kiosk to specify whether he/she wants to retrieve the stored numbers. In any event, while the user is provided with sufficient means to select the gaming he/she desires, it is generally desirable to minimize the amount of, and simplify, user operation, for example, for providing transaction and credit data.

After the user has completed selection of desired lottery numbers, transaction data for the lottery ticket transaction and the card data may be sent out to the credit agency for approval of credit for the lottery ticket purchase. If the transaction is approved, the kiosk communicates through an electronic communication interface with the lottery machine in the convenience store or gas station office, or with a central lottery computer. After the remote gaming machine processes the lottery ticket request from the kiosk, a confirmation is transmitted to the kiosk. If a Quick Pick is also requested, the remote lottery machine randomly selects numbers and also transmits the randomly selected numbers to the kiosk. The numbers then may be displayed and/or a receipt printed on a receipt printer integrated with the gas dispenser or a printer at the separate kiosk unit. Thus, the customer may purchase lottery tickets without entering the gas station office or convenience store.

Typically, the gaming ticket purchase totals one or a few dollars, and therefore may not be enough (and it may not be efficient) to constitute a separate credit card transaction. Accordingly, the gaming purchase may be added to the gas purchase. On the other hand, some customers may purchase a large number of gaming tickets, which would warrant a separate transaction.

The kiosk may have a high quality, interactive display screen (for example, large flat panel display), and may be located at a high consumer traffic location, such as near a gas pump at a high-volume retail gas station. The vicinity of the gas pump provides a particularly suitable venue because consumers are captive viewers while pumping gas. Therefore, the display screen may be located at the side of the pump to allow the consumer to look at something other than the gas pump and be occupied by messages on the display screen.

Timely and essential information, as well as highly targeted advertising content, may be delivered visually to the consumers while they are in the process of pumping gasoline at the gas pump. The advertising content may be delivered during a typical 3.5 minute average viewing time, when the typical consumer is at the pump. This is a suitable time to advertise related automotive products or other merchandise available in the gas station or adjoining convenience store, in addition to gaming tickets, since the consumer at the gas pump has already entered the purchase cycle by initiating a gasoline purchase transaction.

Selective, current and relevant content may be shown on the display to each consumer once the consumer has swiped his/her transaction card or begun the fueling cycle. For example, the display screen may inform the consumer of breaking news, traffic, sports and local weather. In addition, merchandise sold in the convenience store or the gas station, as well as other products the consumer may purchase while at the pump, may be advertised on the display screen. The electronic nature of the content displayed on the display screens allows the content to be changed rapidly to suit fast moving advertising and sales opportunities.

Programming, advertising and product offerings may be tailored to the individual consumer based on profiles, including specific consumer profile and/or demographics, that are maintained in a centralized database and, periodically or upon request, downloaded to the kiosk. Thus, the advertising may be “waste-free” and the probability of the consumer consummating a targeted transaction may be maximized.

The advertising may target specific demographics and viewers. A message may have an associated category profile. The targeted advertising clip may be shown only to those customers who, based on the card data and/or stored information corresponding to the consumer, meet the selected profiles. The advertiser may be billed only for showing their message to those customers who meet the selected profile, and thereby obtains the benefit of savings by not paying to reach less desirable consumers who do not meet the targeted profile. Thus, advertisers may target specific demographics and reach only those consumers who meet a particular profile.

Merchandise offerings may be targeted by language, culture, income, region, buying habits and other criteria. Content played at one station may be different from nearby stations. Messages, content, advertising and merchandising may be changed quickly and tailored to the time of day. Also, the presentations may be adjusted based on specific consumer profile, and thus the probability of consummating transactions with any particular consumer may be increased.

Products may also be offered for sale via selected infomercials shown on the display. For example, easily recognizable products commonly purchased on impulse, such as compact disks, videotapes, DVDs, books and other items may be offered, in addition to gaming tickets.

“Soft” pushbuttons (such as now available on many ATM terminals) may be provided adjacent to the main message screen, so that the consumer has means to interact with the messages, advertisements and infomercials displayed on the main screen. More importantly, it allows the consumer to initiate an immediate purchase of merchandise without waiting on a line or any interaction with store personnel. When the consumer initiates the purchase of a product, the consumer's transaction card may be charged for the merchandise immediately or upon confirmation that the item has been shipped to the consumer. For merchandises that are not at the station/store, an electronic order may be automatically forwarded to the merchandise manufacturer or the fulfillment jobber, and the purchased merchandise may be sent directly to the consumer. For example, the item(s) may be shipped to the consumer's registered card address. For cash customers, the item(s) may be shipped to, for example, an address corresponding to a published telephone number or any other appropriate method to obtain the appropriate shipping address.

In accordance with the present invention, lottery and/or other gaming tickets (when legally permitted) are sold at or near a fuel dispenser (for example, a gas pump) through a kiosk.

The kiosk may be a distinct physical structure or may be integrated in the fuel dispenser. In an embodiment in which the kiosk is integrated inside the dispenser housing, the fuel dispenser may be modular to allow other features and options to be added later. These options might include a cash acceptor or a video screen. When the kiosk is integrated into the dispenser housing, it may remain separate from the fuel dispenser, and not control or affect the fueling process. Thus, in an event of failure of the kiosk, the fuel dispenser continues to operate in a normal fashion.

A user may select a game of chance by pressing a button on the fuel dispenser or, in an embodiment in which the kiosk is a separate unit from the fuel dispenser, on the kiosk located next to the fuel dispenser, or by pressing a graphical button on a touchscreen display. The lottery tickets may be purchased by using a card reader/cash acceptor integrated in the fuel dispenser or in the separate kiosk unit (see, for example, FIG. 1C), to make payment. The purchase of lottery tickets may be added to a gasoline purchase transaction at the fuel dispenser, and a receipt is printed on the receipt printer at the fuel dispenser. Instant prize coupons for discounts on store merchandise and free goods also may be printed.

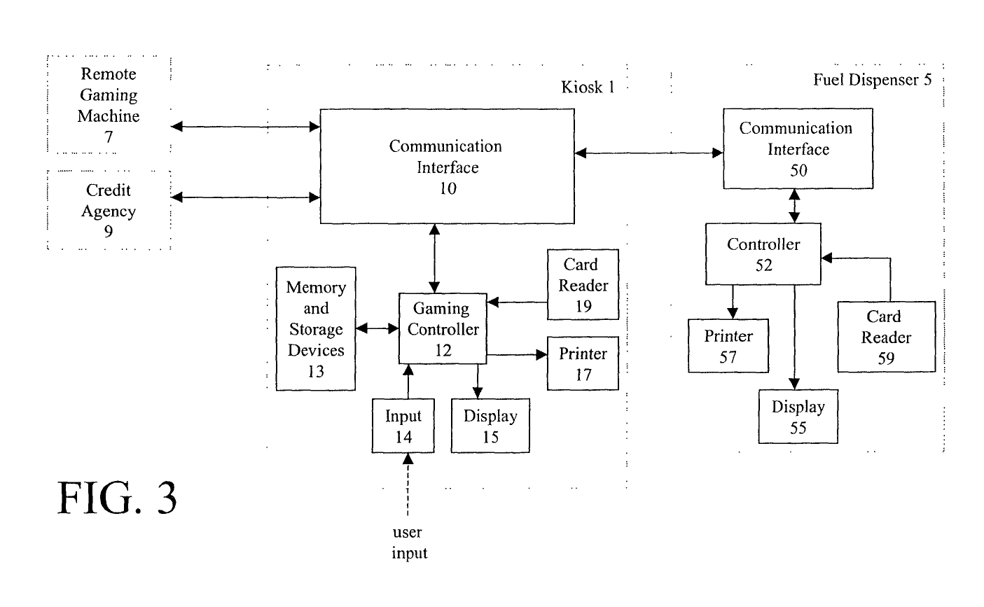

A system with a gaming ticket kiosk, according to an embodiment of the present invention, will be described with reference to FIG. 3.

Kiosk 1 may comprise communication interface 10, gaming controller 12, memory and other storage devices 13, input devices 14, display 15, printer 17 and card reader 19.

In addition to card reader 19, the input devices may include a keypad, mouse, track ball, stylus, microphone, touch screen, etc., plus the appropriate device drivers and user interface software. Also, a speaker as well as other output devices may be included.

Communication interface 10 may include interfaces for connecting to a remote gaming machine, the fuel dispenser interface nearby, and a credit agency or other bank or financial institution, respectively, as well as connecting to one or more other telecommunicative/computer networks, which may include the Internet, an intranet, an extranet, a LAN (local area network), a WAN (wide area network), a wireless network, a satellite network and other networks. For example, consumer profiles and/or demographics information may be downloaded through the networks from a remote centralized database. Communication interface 10 includes the appropriate units for interfacing with these networks, including, for example, Ethernet card, modem, wireless modem, etc.

The kiosk may communicate with the credit agency or other bank or financial institution through one or more wireless or landline telecommunicative networks. Interfaces for such communication are well known. Similarly, the interface with the remote lottery machine may be wired or wireless, in any of many possible configurations that would be known to one skilled in the art. Therefore, the interface to the credit agency or other bank or financial institution and the interface to remote lottery machine are not described in detail here.

The communication interface includes an interface for the kiosk to communicate electronically with the fuel dispenser. The communication interface between the kiosk and the fuel dispenser depends in part on the fuel dispenser which may use any one of many different known interfaces. For example, the interface may include an RS-232 serial interface or some other standard interface.

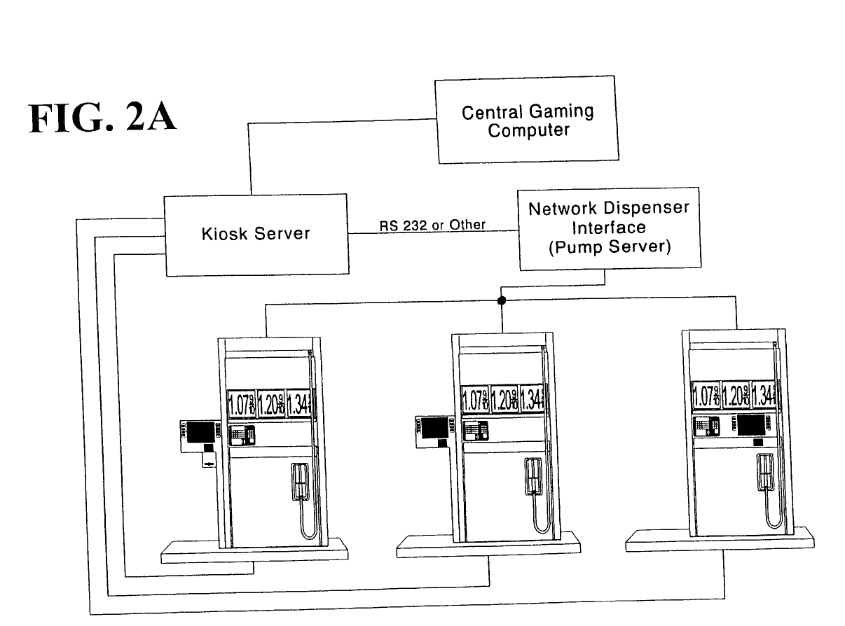

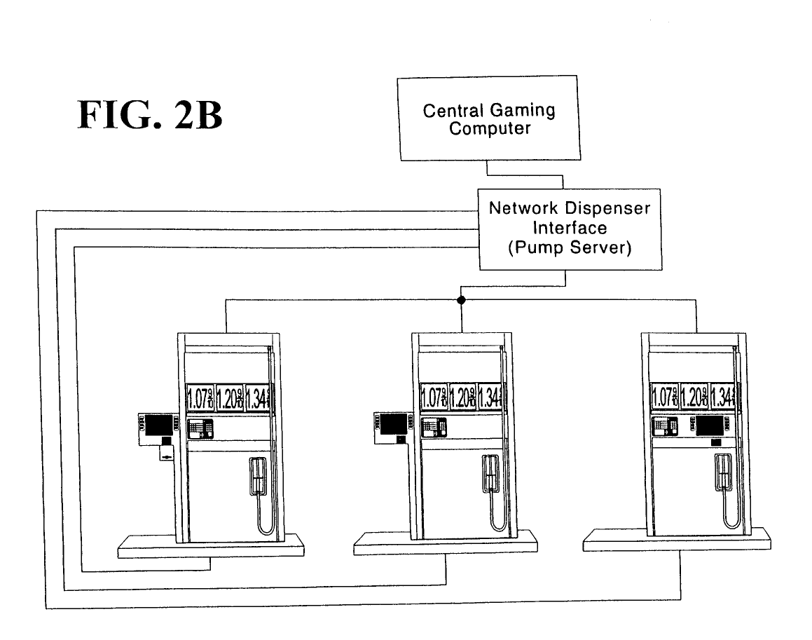

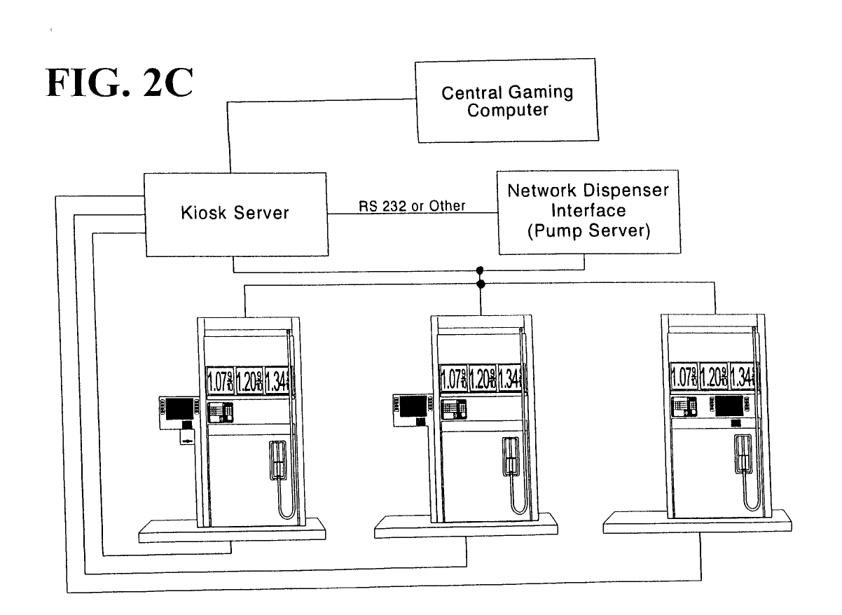

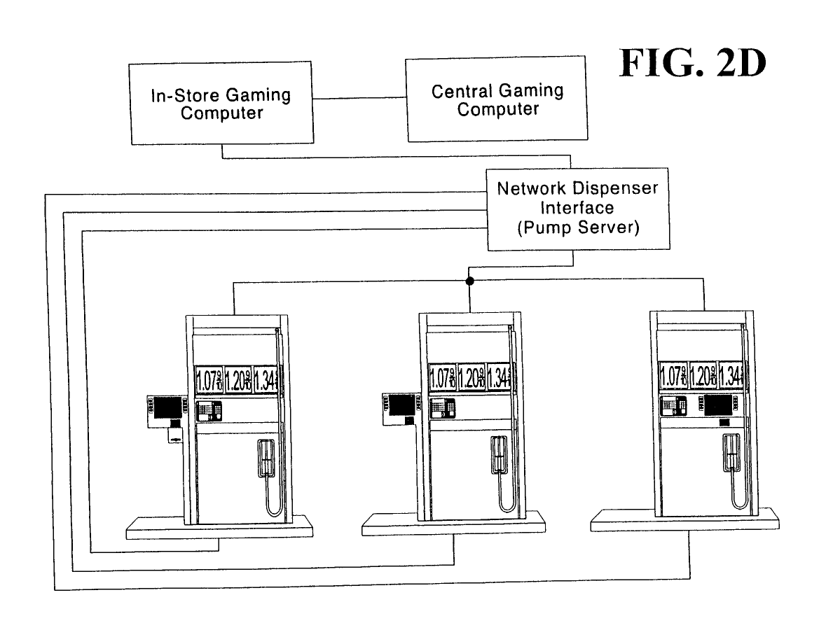

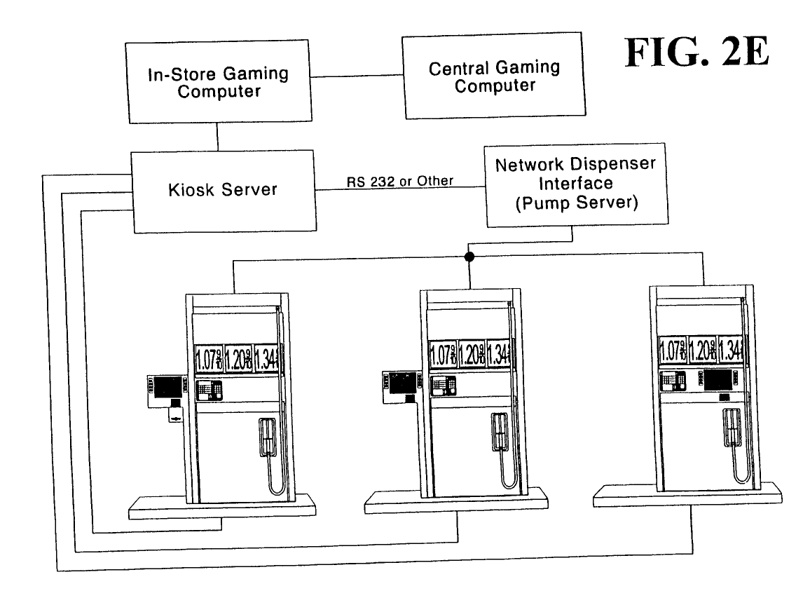

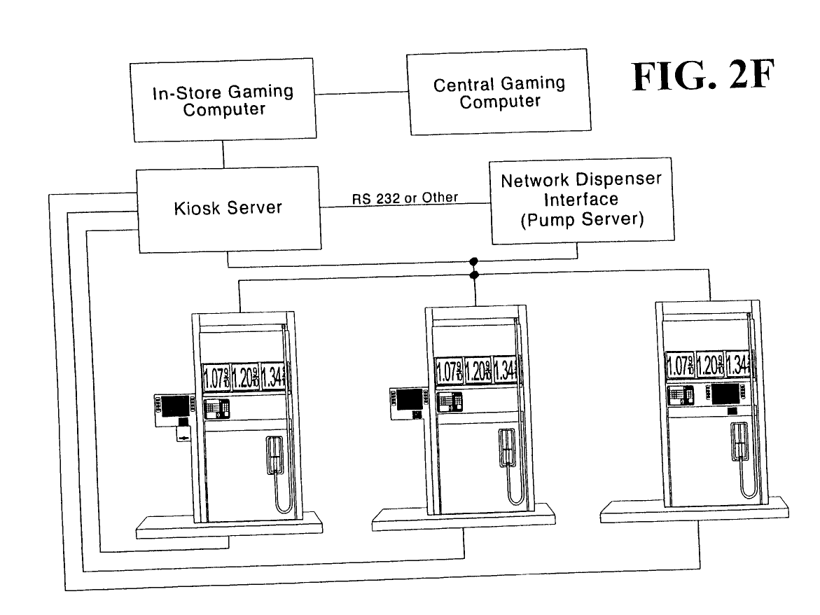

A plurality of fuel dispensers may be connected through a network dispenser interface, which functions as a server for the fuel dispensers. The kiosk may communicate, with (see, for example, FIG. 2A) or without (see, for example, FIG. 2B) going through a kiosk server (described in more detail below), via the network dispenser interface with the fuel dispenser. The kiosk may communicate, in accordance with another embodiment, directly with the fuel dispenser. In another embodiment, the kiosk may communicate through a kiosk server with the fuel dispenser, without going through the network dispenser interface (see, for example, FIG. 2C).

The kiosk has an electronic interface system through which the kiosk communicates with a remote gaming ticket machine, such as inside a convenience store or gas station office. The kiosk may communicate directly (see, for example, FIGS. 2A-2C), or through an in-store gaming ticket machine (see, for example, FIGS. 2D-2F), with a central lottery computer. Also, the kiosk may communicate through a kiosk server (see, for example, FIGS. 2A and 2C) and/or through a network dispenser interface (see, for example, FIG. 2B) with the central lottery computer. In another embodiment, the kiosk communicates through the kiosk server (see, for example, FIGS. 2E and 2F) or network dispenser interface (see, for example, FIG. 2D), via the in-store gaming ticket machine, with the central lottery computer.

The kiosk server can receive and process requests from the kiosks to communicate, through the network dispenser interface, with one of the fuel dispensers, and requests to communicate with a central gaming computer with or without going through an in-store gaming computer. The kiosk server may receive/transmit, store and process information, data or graphics/video, in real-time or periodically, from/to various sources/destinations, such as a computer server, Web server, hand-held device server, in-vehicle navigation server, a satellite communication server and other internet servers. For example, the kiosk server may receive and store information from one of the sources mentioned above, process the information/data based on a kiosk's format requirement, and forward the processed information/data to the kiosk.

The memory devices may be one or a combination of buffers, registers and memories [for example, read-only memory (ROM), programmable ROM (PROM), erasable PROM (EPROM), electrically erasable PROM (EEPROM), non-volatile random access memory (NOVRAM), etc.]. The other storage devices may include, for example, floppy disk drive, CD (or DVD) drive and a hard disk, etc. The memory and storage devices store code and data for the gaming controller 12.

Gaming controller 12 coupled with software components control kiosk operations and functionalities. As shown, for example, in FIG. 3, gaming controller 12 may be connected to each of the other components in the kiosk. Gaming controller 12 may be a suitably programmed microprocessor or microcontroller, an application specific integrated circuit (ASIC), a programmable logic device, or, as one skilled in the art would understand and appreciate, a collection of discrete components suitably laid out and connected on a printed circuit board.

The software components may include a graphical user interface (including transaction card consumer interface), transaction hardware management functions and interfaces to other software packages. In addition, the software components provide digital media distribution (DMD) and transaction processing functionalities. The software components also include assorted device drivers, including a wireless communication driver if a wireless interface is provided. The software components may be installed/stored in the memory and storage devices, and/or communicated through the communication interface via a network, such as the Internet, and/or a wireless transmission medium. Further, each software component may comprise one or more segments, subsets of which are retrieved, from the computer hard disk or via the network or transmission medium, as need arises.

The functionalities of the system may depend on the hardware and software implementation (for example, buttons and other actuators, as opposed to, or in combination with, graphical means on a touchscreen display). The functionalities may be combined/split or otherwise modified to ease the design, manufacture and serviceability of the system. Thus, functions may be implemented typically by, for example, a combination of software and hardware components.

The system includes displays and other components that can be used in outdoor environments. The components preferably can operate in all outdoor environments, ranging from the cold of winter to the heat of summer. High video/audio quality and operating performance in an outdoor environment, preferably coupled with interactivity, may be provided in order to capture and retain the attention of the customer, as well as effectively deliver product marketing and proper presentation of TV quality advertising. Although a high quality, interactive flat panel display is preferred, other liquid crystal displays, light-emitting diode display, cathode ray tube displays, and other display technologies may be used.

While embodiments of the present invention have been described in detail above, it should be understood that the invention is not limited to the precise embodiments described.

For example, in the embodiments described above, a card reader through which a customer may swipe his/her transaction card is provided. The card/identification data may, also or alternatively, be provided through other techniques, for example, RF transmission, EZ Pass, key tag (such as Mobil Fast Pass), and other technologies. Further, payment may be accepted through cash acceptors, in addition to card readers, installed in the fuel dispenser and/or in the kiosk.

Further, while the kiosk is near, or integrated within, a fuel dispenser in the embodiments described above, the kiosk may be provided at other point-of-purchase locations, such as mass transit locations (e.g., bus stop/terminal, train station, airport, etc.), malls, fast food outlets and other high traffic locations where consumers may stop, with adaptations specific to those locations.

Other improvements and modifications which become apparent to persons of ordinary skill in the art after reading this disclosure, the drawings and the appended claims are deemed within the spirit and scope of the present invention.

What is claimed is:

1. An apparatus for selling gaming tickets at a fuel dispenser, comprising:
a communication interface comprising a first interface and a second interface, wherein the first interface is adapted to communicate electronically with a remote gaming machine, and the second interface is adapted to communicate electronically with the fuel dispenser; and
a gaming controller coupled to the communication interface to communicate with the remote gaming machine and with the fuel dispenser, wherein the gaming controller is adapted to monitor whether a user is using the fuel dispenser, and, after determining that the fuel dispenser is being used, triggers a user interface through which the user can select a desired game of chance.

2. The apparatus of claim 1, wherein the apparatus is a gaming ticket kiosk unit distinct from the fuel dispenser.

3. The apparatus of claim 1, wherein the apparatus communicates electronically with the fuel dispenser through the communication interface and a kiosk server.

4. The apparatus of claim 1, wherein the apparatus communicates electronically with the fuel dispenser through the communication interface and a network dispenser interface.

5. The apparatus of claim 1, wherein the apparatus communicates electronically with the fuel dispenser through the communication interface, a kiosk server and a network dispenser interface.

6. The apparatus of claim 1, wherein the apparatus communicates electronically with a central gaming computer through the communication interface and a kiosk server.

7. The apparatus of claim 1, wherein the apparatus communicates electronically with a central gaming computer through the communication interface, a kiosk server and an in-store gaming computer.

8. The apparatus of claim 1, wherein the apparatus communicates electronically with a central gaming computer through the communication interface and a network dispenser interface.

9. The apparatus of claim 1, wherein the apparatus communicates electronically with a central gaming computer through the communication interface, a network dispenser interface and an in-store gaming computer.

10. The apparatus of claim 1, wherein the selected game is a legal game of chance other than a lottery.

11. The apparatus of claim 1, wherein the selected game is a lottery.

12. The apparatus of claim 11, wherein the remote gaming machine includes a central lottery computer.

13. The apparatus of claim 11, wherein the gaming controller includes means for the user to select one or more desired lottery numbers.

14. The apparatus of claim 11, wherein the gaming data communicated from the gaming controller through the first interface to the remote gaming machine includes a request for a Quick Pick.

15. The apparatus of claim 11 further comprising a display screen, wherein Quick Pick numbers from the remote gaming machine are received through the first interface and displayed on the display screen.

16. The apparatus of claim 1 further comprising a keypad, wherein gaming parameters corresponding to the game of chance are selected by the user using the keypad.

17. The apparatus of claim 1 further comprising a touchscreen display, wherein desired gaming parameters corresponding to the game of chance are selected by the user through a keypad interface in the touchscreen.

18. The apparatus of claim 1 further comprising a video display, wherein an infomercial corresponding to the game of chance is selectively displayed on the video display.

19. The apparatus of claim 1 further comprising a printer, wherein after a gaming transaction is completed, a receipt of the gaming transaction is printed by the printer.

20. The apparatus of claim 1, wherein, after confirmation of the selected game is received from the remote gaming machine through the first interface, a request for an integrated printer of the fuel dispenser to print a gaming receipt corresponding to the selected game is communicated to the fuel dispenser through the second interface.

21. The apparatus of claim 1 further comprising a printer, wherein an instant prize coupon for discount on selected merchandise is printed by the printer for selected customers.

22. The apparatus of claim 1 further comprising a card reader, wherein the communication interface further comprises a third interface adapted to communicate electronically with a credit agency, card data is obtained through the card reader from a transaction card supplied by the user, and transaction data and the card data are communicated through the third interface to the credit agency.

23. The apparatus of claim 22, wherein after approval of credit for the gaming transaction is communicated by the credit agency to the apparatus through the third interface, gaming data corresponding to the selected game is communicated to the remote gaming machine through the first interface.

24. The apparatus of claim 1, wherein card data is obtained through a card reader integrated with the fuel dispenser from a transaction card supplied by the user to initiate a fuel purchase transaction, and the card data obtained through the card reader is communicated electronically from the fuel dispenser to the apparatus through the second interface.

25. The apparatus of claim 24, wherein the communication interface comprises a third interface adapted to communicate electronically with a credit agency, and transaction data and the card data are communicated through the third interface to the credit agency, after the selected game is selected by the user, to obtain approval of credit for the gaming transaction.

26. The apparatus of claim 1 further comprising a cash acceptor, wherein cash payment for a gaming transaction is accepted through the cash acceptor.

27. A method for selling gaming tickets at a fuel dispenser, comprising the steps of:
(a) providing a gaming ticket kiosk in a physical proximity of the fuel dispenser, wherein the gaming ticket kiosk has a gaming controller and a communication interface;
(b) monitoring through the gaming controller whether fuel is being dispensed by the fuel dispenser;
(c) providing a user interface through which a user can select a desired game of chance, after it is determined in step (b) that fuel is being dispensed by the fuel dispenser; and
(d) communicating electronically through the communication interface to a remote gaming machine from the gaming ticket kiosk gaming data corresponding to a selected game.

28. A method for selling gaming tickets using a gaming ticket kiosk in a physical proximity of a fuel dispenser, the gaming ticket kiosk having a gaming controller and a communication interface, comprising the steps of:
(a) monitoring through the gaming controller whether a user is using the fuel dispenser;
(b) providing a user interface through which the user can select a desired game of chance, after it is determined in step (a) that the fuel dispenser is being used; and
(c) communicating electronically through a communication interface to a remote gaming machine from the gaming ticket kiosk gaming data corresponding to the desired game selected through the user interface provided in step (b).

29. The method of claim 28 further comprising receiving a signal at the gaming ticket kiosk from the fuel dispenser when a fuel purchase transaction commences at the fuel dispenser.

30. The method of claim 28 further comprising receiving a signal at the gaming ticket kiosk from the fuel dispenser when a fuel pump handle at the fuel dispenser has been lifted from a resting position.

31. The method of claim 28 further comprising printing gaming receipts through a receipt printer of the gaming ticket kiosk.

32. The method of claim 28 further comprising printing gaming receipts through a receipt printer of the fuel dispenser.

33. The method of claim 28 further comprising communicating electronically with the fuel dispenser through the communication interface and a kiosk server.

34. The method of claim 28 further comprising communicating electronically with the fuel dispenser through the communication interface and a network dispenser interface.

35. The method of claim 28 further comprising communicating electronically with the fuel dispenser through the communication interface, a kiosk server and a network dispenser interface.

36. The method of claim 28 further comprising communicating electronically with a central gaming computer through the communication interface and a kiosk server.

37. The method of claim 28 further comprising communicating electronically with a central gaming computer through the communication interface, a kiosk server and an in-store gaming computer.

38. The method of claim 28 further comprising communicating electronically with a central gaming computer through the communication interface and a network dispenser interface.

39. The method of claim 28 further comprising communicating electronically with a central gaming computer through the communication interface, a network dispenser interface and an in-store gaming computer.

40. The method of claim 28 further comprising reading card data from a transaction card supplied by the user through a card reader integrated with the gaming ticket kiosk, and communicating transaction data and the card data to a credit agency to request approval of credit for the gaming transaction.

41. The method of claim 28 further comprising reading card data from a transaction card supplied by the user through a card reader integrated with the fuel dispenser, and communicating the card data to the gaming ticket kiosk.

42. The method of claim 28 further comprising adding to a fuel purchase transaction at the fuel dispenser a purchase of at least one gaming ticket corresponding to the selected game.

43. The method of claim 28 further comprising printing an instant prize coupon for a discount on a selected merchandise, for selected users.
